(19) United States
(12) Patent Application Publication
(10) Pub. No.: US 2026/0175866 A1
(43) Pub. Date: Jun. 25, 2026

(54) OCCUPANT IMPAIRMENT DETECTING AND ADDRESSING SYSTEM

(71) Applicant: TOYOTA MOTOR ENGINEERING & MANUFACTURING NORTH AMERICA,INC., PLANO, TX (US)

(72) Inventors: ROHIT GUPTA, Santa Clara, CA (US); AHMADREZA MORADIPARI, Mountain View, CA (US); SERGEI S. AVEDISOV, Mountain View, CA (US); ONUR ALTINTAS, Mountain View, CA (US)

(73) Assignees: TOYOTA MOTOR ENGINEERING & MANUFACTURING NORTH AMERICA,INC., PLANO, TX (US); TOYOTA JIDOSHA KABUSHIKI KAISHA, TOYOTA-ShI (JP)

(21) Appl. No.: 18/988,780

(22) Filed: Dec. 19, 2024

(51) Int. Cl. B60W 60/00; B60W 30/165; B60W 40/08; G06V 20/59; G08G 1/00; H04W 4/46

(52) U.S. Cl. CPC B60W 60/001; B60W 30/165; B60W 40/08; G06V 20/597; G08G 1/22; H04W 4/46; B60W 2040/0872; B60W 2420/403; B60W 2540/22; B60W 2540/221; B60W 2554/80; B60W 2556/65

(57) ABSTRACT

A system includes sensors that obtain occupant data of an occupant within the ego vehicle. The ego vehicle is part of a platoon of vehicles. The system includes one or more processors, and a memory storing instructions that, when executed by the one or more processors, cause the system to perform operations. The operations include determining, based on the occupant data, an impairment status of the occupant; and in response to determining the impairment status, selectively implementing an action to address the impairment status. The action includes communicating, using one or more coded status messages, at least a portion of the impairment status to one or more other vehicles in the platoon, and implementing a navigation action of the ego vehicle.

### TECHNICAL FIELD

The present disclosure relates generally to detecting an impairment of an occupant within a vehicle and addressing the impairment. Some aspects of the disclosure relate to addressing the impairment by communicating the impairment to other vehicles.

### DESCRIPTION OF RELATED ART

Vehicle-to-Everything (V2X) communication facilitates vehicle communication regarding sensor data and internal operations with other vehicles, other road users such as pedestrians, and road infrastructure. V2X is implemented to improve road safety, traffic efficiency, and environmental conditions. In the United States, the National Highway Traffic Safety Administration (NHTSA) estimates that development of V2X technologies has resulted in, or will result in, at least a 13 percent reduction in traffic accidents.

### BRIEF SUMMARY OF THE DISCLOSURE

According to various embodiments of the disclosed technology, a system associated with a vehicle (e.g., an ego vehicle) comprises one or more sensors (e.g., interior or in-cabin sensors within the vehicle) configured to configured to obtain occupant data of an occupant within the ego vehicle, where the ego vehicle is part of a platoon of vehicles. The system comprises one or more processors. The system comprises a memory storing instructions that, when executed by the one or more processors, cause the system to perform operations. The operations include determining or obtaining, based on the occupant data, an impairment status of the occupant; and in response to determining the impairment status, selectively implementing an action to address the impairment status. The action comprises communicating, using one or more coded status messages, at least a portion of the impairment status to one or more other vehicles in the platoon; and implementing a navigation action of the ego vehicle.

In some embodiments, the impairment status indicates a type or a severity level of an impairment of the occupant.

In some embodiments, the impairment status indicates the severity level of the impairment, and the severity level is based on a degree of control of physical or mental faculties maintained by the occupant following the impairment.

In some embodiments, the one or more coded status messages indicate a presence or absence of another vehicle of the platoon at least a threshold distance within the ego vehicle.

In some embodiments, the system comprises a database system, and the communicating of at least the portion of the impairment status is directed to one or more other database systems associated with one or more respective other vehicles in the platoon.

In some embodiments, the communicating of at least the portion of the impairment status comprises: broadcasting the one or more coded status messages at a frequency; obtaining a changed impairment status; and in response to obtaining the changed impairment status, changing the frequency at which the one or more coded status messages corresponding to the changed impairment status is broadcasted.

In some embodiments, the one or more sensors are further configured to obtain one or more navigation characteristics, the navigation characteristics being indicative of a degree of stability of navigation of the ego vehicle, and the determining of the impairment status is based on the one or more navigation characteristics.

In some embodiments, the impairment status comprises a type of the impairment, and the type of the impairment comprises a medical-related impairment excluding inebriation.

In some embodiments, the type of the impairment comprises a cardiovascular impairment.

In some embodiments, the navigation action causes an ego vehicle navigation characteristic of the ego vehicle to change with respect to a navigation characteristic of a different vehicle within the platoon.

According to various embodiments of the disclosed technology, a vehicle control system comprises a processor; and a memory coupled to the processor to store instructions, which when executed by the processor, cause the processor to perform operations. The operations comprise obtaining occupant data from one or more sensors, the occupant data being associated with an occupant within an ego vehicle, wherein the vehicle is part of a platoon of vehicles; determining, based on the occupant data, an impairment status of the occupant; and in response to determining the impairment status, selectively implementing an action to address the impairment status, wherein the action comprises: communicating, using one or more coded status messages, at least a portion of the impairment status to one or more other vehicles in the platoon; and implementing a navigation action of the ego vehicle.

In some embodiments, the vehicle control system comprises a plurality of database systems associated with respective other vehicles in the platoon, and the communicating of at least the portion of the impairment status comprises communicating, from a database system associated with the ego vehicle, to at least a portion of the plurality of database systems.

In some embodiments, the operations further comprise obtaining one or more navigation characteristics, the navigation characteristics being indicative of a degree of stability of navigation of the ego vehicle; and the determining of the impairment status is based on the one or more navigation characteristics.

Previous features described with respect to the vehicle system may also be applicable to the vehicle control system.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example of an all-wheel drive hybrid vehicle with which embodiments of the systems and methods disclosed herein may be implemented.

FIG. 3 illustrates an example architecture for detecting and addressing an impairment status of an occupant within an ego vehicle, in accordance with one embodiment of the systems and methods described herein.

FIG. 4 illustrates a representation of a platoon, in which an ego vehicle participates, in accordance with one embodiment of the systems and methods described herein.

FIG. 5 illustrates a platoon system, which includes one or more computer systems and/or database systems that coordinate operations of a platoon, in accordance with one embodiment of the systems and methods described herein.

FIG. 6 illustrates an example coded status message transmitted from an ego vehicle to other vehicles of a platoon, in accordance with one embodiment of the systems and methods described herein.

FIGS. 7-8 illustrate scenarios of a platoon in which an impairment of an occupant in an ego vehicle causes a change in the platoon, in accordance with one embodiment of the systems and methods described herein.

FIG. 9 is an example computing component that may be used to implement various features of embodiments described in the present disclosure.

The figures are not exhaustive and do not limit the present disclosure to the precise form disclosed.

### DETAILED DESCRIPTION

An occupant impairment addressing system of an ego vehicle may address a situation in which an occupant within the ego vehicle is impaired, in order to ensure safety and well-being of the occupant, the ego vehicle, and surrounding traffic. To address this type of situation, the occupant impairment addressing system may obtain impairment data and/or otherwise receive an indication of impairment data. The impairment data may be associated with an occupant of the ego vehicle. The impairment data may indicate or predict an impairment status. An impairment status may include any of an existence of an impairment, a probability of impairment of an occupant, and if impaired or likely impaired (e.g., having more than a threshold probability of being impaired), a type and/or a severity of impairment. Possible types of impairment may include, exhaustion, drowsiness, fitness impairment, medical-related impairments such as vision impairments, olfactory impairments, auditory impairments, tactile impairments, or cardiovascular impairments (e.g., cardiac arrest or other cardiovascular conditions) excluding inebriation, and/or substance-related impairments such as those related to inebriation, cannabis, drugs, or medications.

The impairment data may be obtained directly or indirectly from raw or processed sensor data captured by one or more sensors, such as cameras, eye tracking sensors, and steering wheel monitoring systems. In particular, cameras may include infrared cameras that monitor an occupant's eyes, face, and/or head movements. In some embodiments, the raw sensor data may be analyzed using one or more algorithms or models to determine or predict the impairment status. The algorithms or models may be part of the occupant impairment addressing system, and/or may be part of a remote system, such as a cloud, cellular, or edge-based system.

Upon determining, obtaining, or predicting an impairment status, the occupant impairment addressing system may determine and implement an appropriate action. Such an action may include transmitting, via a coded message, an indication of the impairment status to one or more other vehicles, and/or communicating the impairment status to an external source in order to request assistance for the ego vehicle and/or for any impaired occupants. In some embodiments, the occupant impairment addressing system may control certain navigation actions of the ego vehicle, such as limiting a range of permitted navigation actions, switching one or more modes, pulling over to a side of a road, and/or shut down.

In some embodiments, the occupant impairment addressing system may be implemented within a context of a platoon or fleet (hereinafter “platoon.”). In some embodiments, a platoon may include a group of vehicles configured to communicate with one another and cooperating or coordinating to perform a function or task, such as following. The ego vehicle may be part of the platoon as a following vehicle or a lead vehicle. Specifically, a platoon may include a group of vehicles in which navigation characteristics among the vehicles are to be synchronized such as in a motorcade. Navigation characteristics may include any or all of a position, velocity, acceleration, or heading. Other navigation characteristics may include navigation patterns and/or navigation behaviors such as a degree of stability of navigation, and/or an extent to which a planned trajectory is followed. In other embodiments, a platoon may include a group of vehicles configured to communicate with one another, with or without coordinating with one another to perform a task. The occupant impairment addressing system may be configured to receive an impairment status of one or more occupants in other vehicles of the platoon. The occupant impairment addressing system may be configured to transmit or broadcast an impairment status of one or more occupants in the ego vehicle to one or more other vehicles of the platoon. In some embodiments, the occupant impairment addressing system may be configured to remove, or coordinate removal of, the ego vehicle from the platoon, upon detecting a particular impairment status of an occupant. In some embodiments, the occupant impairment addressing system may be configured to change, or program a change in, a role or status of the ego vehicle within the platoon upon detecting a particular impairment status.

The occupant impairment addressing system provides technical benefits including, using a vehicle-based computer system to more effectively detect and address a wide range of different impairments of occupants. For example, the occupant impairment addressing system implements an improved communication mechanism including generating coded status messages indicative of an impairment status of an occupant. The coded status messages are efficiently transmitted to one or more other vehicles of the platoon and rapidly deciphered by other vehicles. In addition, the occupant impairment addressing system participates in communication between different computer systems or database systems, to coordinate and/or collaborate to efficiently address a situation of an occupant impairment within a vehicle.

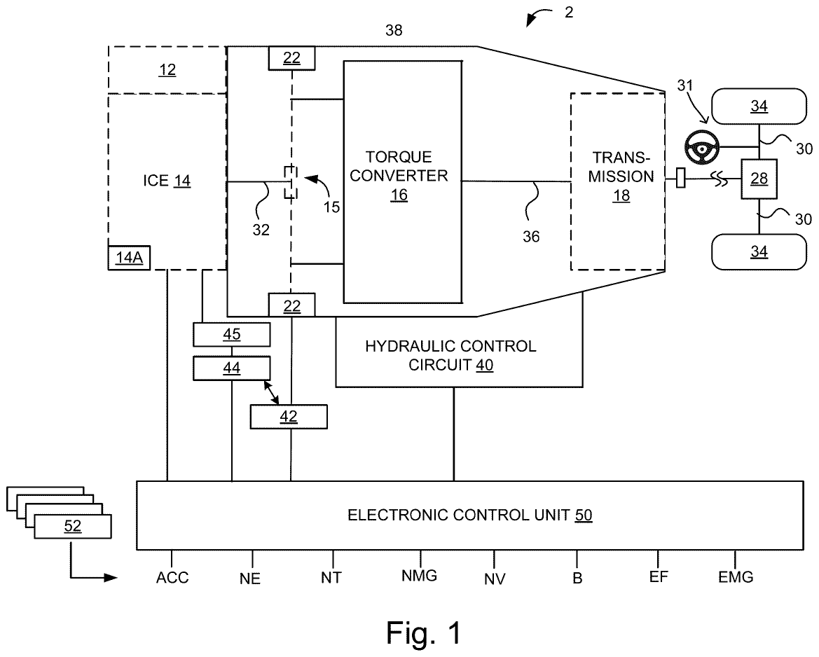

The systems and methods disclosed herein may be implemented with any of a number of different ego vehicles and ego vehicle types. For example, the systems and methods disclosed herein may be used with automobiles, trucks, motorcycles, recreational vehicles and other like on- or off-road vehicles. In addition, the principles disclosed herein may also extend to other vehicle types as well. An example hybrid electric vehicle (HEV) in which embodiments of the disclosed technology may be implemented as an ego vehicle and is illustrated in FIG. 1. Although the example described with reference to FIG. 1 is a hybrid type of ego vehicle, the systems and methods for driver fitness assessment can be implemented in other types of ego vehicles including gasoline- or diesel-powered vehicles, fuel-cell vehicles, electric vehicles, or other vehicles.

FIG. 1 illustrates a drive system of an ego vehicle 2 that may include an internal combustion engine 14 and one or more motors 22 (e.g., electric motors, which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30. The ego vehicle 2 may include a steering system 31. The steering system 31 may be implemented via electronic power steering (EPS) or steer-by-wire.

As an HEV, ego vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, ego vehicle 2 relies on the motive force generated at least by internal combustion engine 14, and a clutch 15 may be included to engage engine 14. In the EV travel mode, ego vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in ego vehicle 2 and is powered electrically via a battery 44. Battery 44 may be implemented as one or more batteries or other power storage devices including, for example, lead-acid batteries, nickel-metal hydride batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and braking. As a more particular example, output torque of the motor 22 can be increased or decreased by electronic control unit 50 through the inverter 42. In some embodiments, the electronic control unit 50 may control the steering system 31.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit 40. When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, ego vehicle 2 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50 execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in ego vehicle 2. For example, electronic control unit 50 may receive signals that indicate vehicle operating conditions or characteristics, or signals that can be used to derive vehicle operating conditions or characteristics. These may include, but are not limited to accelerator operation amount, ACC, a revolution speed, NE, of internal combustion engine 14 (engine RPM), a rotational speed, NMG, of the motor 22 (motor rotational speed), and vehicle speed, NV. These may also include torque converter 16 output, NT (e.g., output amps indicative of motor output), brake operation amount/pressure, B, battery SOC (i.e., the charged amount for battery 44 detected by an SOC sensor). Accordingly, ego vehicle 2 can include a plurality of sensors 52 that can be used to detect various conditions internal or external to the vehicle and provide sensed conditions to electronic control unit 50 (which, again, may be implemented as one or a plurality of individual control circuits). In one embodiment, sensors 52 may be included to detect one or more conditions directly or indirectly such as, for example, fuel efficiency, EF, motor efficiency, EMG, hybrid (internal combustion engine 14+cooling system 12) efficiency, acceleration, ACC, etc. In some embodiments, sensors 52 may detect navigation characteristics of the ego vehicle 2. Here, navigation characteristics may include an absolute position, an absolute velocity, an absolute heading, or an absolute acceleration of the ego vehicle 2 or of the obstacle.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

As evident, sensors 52 may be included to detect not only vehicle conditions but also to detect external conditions, such as of other obstacles, as well. Sensors that might be used to detect external conditions can include, for example, sonar, radar, lidar or other vehicle proximity sensors, and cameras or other image sensors. Image sensors can be used to detect, for example, objects such as traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The sensors 52 may be within an interior of a cabin of, or on an exterior of the ego vehicle 2. The sensors 52 may include impairment detecting sensors, such as in-cabin cameras, eye tracking sensors, and steering wheel monitoring systems. In particular, in-cabin cameras may include infrared cameras that monitor an occupant's eyes, face, and/or head to assess a measure of eye, facial, or head movements and/or a degree of stability or eye, facial, or head movements.

The sensors 52 may also include capturing sensors, which capture sensor data within the ego vehicle 2 or within surroundings of the ego vehicle 2. In some embodiments, additional sensors may not be directly connected to the ego vehicle 2, but rather, may be located on a different entity, such as a drone or a stationary landmark such as a traffic light.

The ego vehicle 2 may operate under different levels of autonomy, such as any of Society of Automotive Engineers (SAE) levels between L1 and L5. In some embodiments, the ego vehicle 2 may operate under a level of autonomy, such as L1 or L2, that includes or supports Vehicle-to-Everything (V2X) or Vehicle-to-Vehicle (V2V) communication functionality.

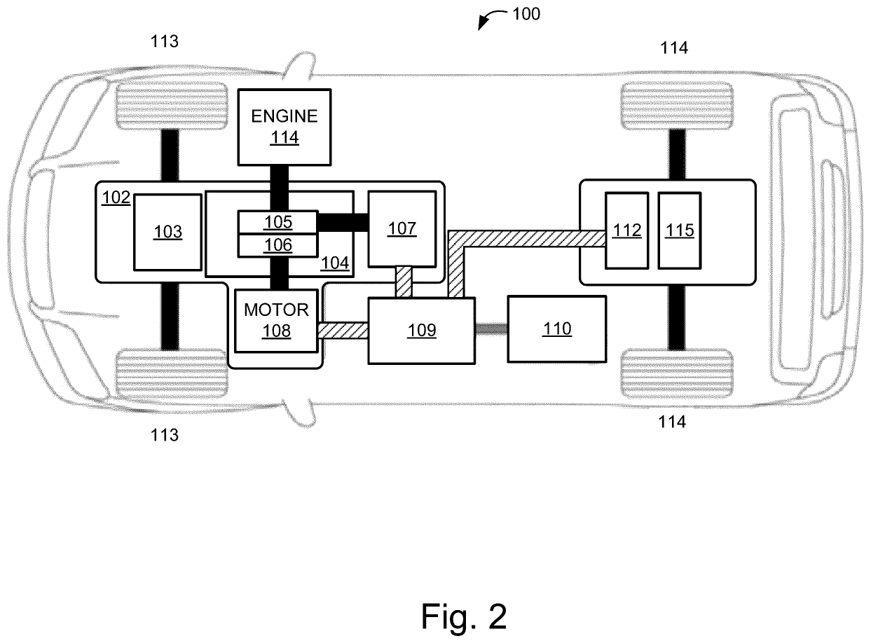

FIG. 2 is another example of an ego vehicle with which systems and methods for assessing occupant fitness can be implemented. The example illustrated in FIG. 2 is also that of a hybrid vehicle drive system of a vehicle 100 that may also include an engine 114 (e.g., internal combustion engine 14) and one or more electric motors 108, 112 (e.g., motors 22) as sources of motive power. In this example, a hybrid transaxle assembly 102 includes front differential 103, a compound gear unit 104, a motor 108, and a generator 107. Compound gear unit 104 includes a power split planetary gear unit 105 and a motor speed reduction planetary gear unit 106. This example vehicle also includes front and rear drive motors 108, 112, an inverter with converter assembly 109, battery 110 (which may include multiple batteries), and a rear differential 115. Hybrid transaxle assembly 102 enables power from engine 101, motor 108, or both to be applied to front wheels 113 via front differential 103.

Inverter with converter assembly 109 inverts DC power from battery 110 to create AC power to drive AC motors 108, 112. In embodiments where motors 108, 112 are DC motors, no inverter is required. Inverter with converter assembly 109 also accepts power from generator 107 (e.g., during engine charging) and uses this power to charge battery 110.

The examples of FIGS. 1 and 2 are provided for illustration purposes only as examples of vehicle systems with which embodiments of the disclosed technology may be implemented. One of ordinary skill in the art reading this description will understand how the disclosed embodiments can be implemented with vehicle platforms.

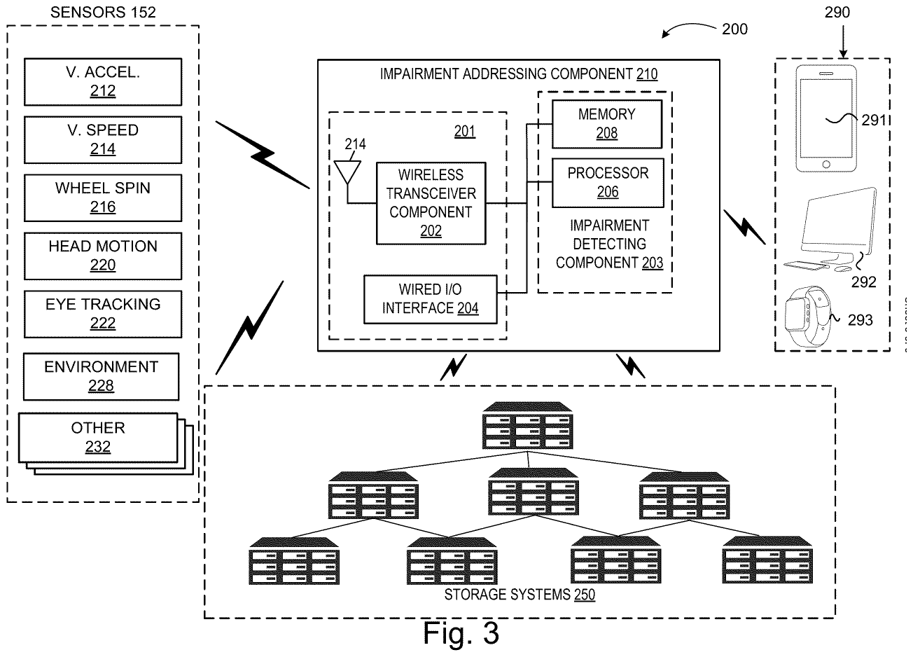

FIG. 3 illustrates an example architecture for adaptively and selectively detecting and addressing occupant impairment of an occupant within the ego vehicle 2. Occupant impairment detecting and addressing system 200 may include a computer system or database system, and may further include an impairment detecting component 203, which detects an impairment status of an occupant. As alluded to, the impairment status may include a type, a severity, and/or a probability of one or more impairments. The severity may include, or be indicative of, a degree of control of physical or mental faculties maintained by the occupant following the impairment. Impairment status may include any impairment conditions such as exhaustion, drowsiness, fitness impairment, medical-related impairments such as vision impairments, olfactory impairments, auditory impairments, tactile impairments, cardiovascular impairments (e.g., cardiac arrest), other bodily impairments (e.g., injured leg, injured ankle), other medical conditions, and/or substance-related impairments such as those related to inebriation, cannabis, drugs, or medications.

Detecting of occupant impairment status may be based on raw and/or analyzed sensor data from sensors 52 and/or sensors 152 illustrated in FIG. 1, in accordance with one embodiment of the systems and methods described herein. In some embodiments, the sensors 52 and/or the sensors 152 may obtain occupant data of occupants within the ego vehicle 2. The occupant data may include characteristics such as eye characteristics, head characteristics, and/or other body characteristics, including motion characteristics of eyes, head, and/or other body parts. The motion characteristics may include a range of motion, and/or a degree of stability and/or variability in the motion. The motion characteristics may include any characteristics indicative of a presence or an absence of an impairment of any type. The impairment detecting component 203 may determine an impairment status of the occupant based on processing of the occupant data.

In some embodiments, detecting of occupant impairment status may be based on one or more tests, such as driver fitness tests. The impairment detecting component 203 may program one or more driver fitness tests which may include a gaze tracking test, a fixed gaze test, a reaction test, or a reading test. The driver fitness tests may encompass outputting a stimuli on a dashboard or a console within the ego vehicle 2 and monitoring one or more characteristics of an occupant in response to the stimuli. The impairment detecting component 203 may monitor characteristics including any impairment sensor data of the occupant as detected by the impairment detecting sensors, of the sensors 52. For example, the characteristics may include gaze characteristics such as a degree of steadiness of gaze and/or degree or stability of head motions or other body movements. Examples of driver fitness tests are described in U.S. application Ser. No. 18/945,434, entitled “Driver Fitness Test” and filed on Nov. 12, 2024, hereinafter incorporated by reference in its entirety.

The detecting of occupant impairment status may additionally or alternatively be based on one or more reaction tests. An example of a reaction test may include issuing a command by the ego vehicle 2 to one or more occupants to perform a certain action, such as a bodily movement or a navigation action. For example, the command may indicate a lane change, a turn, a speed change, or other navigation action. The reaction test may measure a response characteristic of the occupant in performing the certain action. The response characteristic may include a latency, a degree of confidence, and/or a degree of smoothness or swerving while performing the action. In some embodiments, additionally or alternatively, the detecting of an impairment status may include receiving a notification from the occupant himself or herself regarding an impairment status, and/or receiving an indication from one or more other vehicles, whether in a platoon or outside of the platoon, regarding the impairment status. In some embodiments, the impairment status may be detected at least in part using one or more models or algorithms, which may be part of the ego vehicle 2 or remote from the ego vehicle 2, such as in a cloud, edge, or cellular system.

In some embodiments, the impairment detecting component 203 may detect and/or otherwise receive indication of one or more impairment statuses of other occupants in different vehicles, such as different vehicles of a same platoon as the ego vehicle 2. In this manner, the impairment detecting component 203 may coordinate and/or cooperate with other vehicles in a same platoon to address an impairment status for different occupants within different vehicles.

The occupant impairment detecting and addressing system 200 may further include an impairment addressing component 210. The impairment addressing component 210 may perform an action to address an impairment status of an occupant. The action may depend on the impairment status, such as a type, a severity, and/or a probability of an impairment, and/or historical impairment data of a particular occupant. In some embodiments, the action may be determined at least in part using one or more models or algorithms, which may be part of the ego vehicle 2 or remote from the ego vehicle 2. If remote from the ego vehicle 2, the one or more models or algorithms may be within a cloud server, an edge server, or a cellular server. The action may include communicating, transmitting, broadcasting, or propagating (hereinafter “transmitting”) one or more coded status messages to other vehicles, such as other vehicles within a platoon that the ego vehicle 2 belongs to. The coded status messages may be indicative of the impairment status or at least a portion thereof. In some embodiments, the occupant impairment detecting and addressing system 200, the impairment detecting component 203, and/or the impairment addressing component 210, may be part of, or include, a database system. In some embodiments, the communicating of the one or more coded status messages may include directing the communications to one or more other database systems associated with one or more respective other vehicles in the platoon. The action may, additionally or alternatively, include transmitting request messages to request assistance. These messages may be directed, for example, to one or more emergency providers, health providers, or other service providers.

The action may, additionally or alternatively, include controlling, programming, implementing, and/or performing one or more navigation actions of the ego vehicle 2. The navigation action may change a navigation characteristic of the ego vehicle 2 (e.g., an ego vehicle navigation characteristic) with respect to a navigation characteristic of at least one other vehicle within the platoon. For example, if the ego vehicle 2 was previously programmed to maintain a certain threshold distance or range of distances from a lead vehicle and/or from a following vehicle within the platoon, then the change of the navigation characteristic may cause the ego vehicle 2 to deviate from the threshold distance or the range of distances. As another example, if the ego vehicle 2 was previously programmed to navigate within a certain velocity range and/or acceleration range with respect to a lead vehicle and/or a following vehicle, then the change of the navigation characteristic may cause the ego vehicle 2 to deviate from the velocity range and/or acceleration range. For instance, assume for the sake of illustration that the ego vehicle 2 was previously programmed to always be moving at a velocity that is within 2 miles per hour of the velocity of a lead vehicle. The change of the navigation characteristic may result in the ego vehicle 2 travelling at a speed that deviates by more than 2 miles per hour compared to the lead vehicle.

In other examples, the impairment addressing component 210 may impose speed limits of the ego vehicle 2, and/or other navigation limits such as a turning radius limit, a turning limit for a steering wheel, and/or force limits on actuators such as brakes, which were previously not imposed. In other examples, the impairment addressing component 210 may program the ego vehicle 2 to pull over, stop, or shut down.

As alluded to, the action taken to address an impairment status may depend on historical impairment data of a particular occupant. For example, depending on a reaction or reaction level of an occupant in response to impairment, different actions may be taken. For example, if historical impairment data indicates that an occupant previously exhibited a high level of calmness and/or retains substantial control over body faculties despite an impairment, a less drastic action may be taken in response to a current impairment, such as limiting certain navigation actions without stopping the ego vehicle 2 or removing the ego vehicle 2 from a platoon. However, if historical impairment data indicates that an occupant previously exhibited a high level of nervousness or anxiety and/or loses a substantial degree of control over body faculties during an impairment, a more drastic action may be taken in response to a current impairment, such as stopping the ego vehicle 2 or shutting down the ego vehicle 2.

In some embodiments, the impairment addressing component 210 may perform an action to address an impairment status of an occupant belonging to a different vehicle, such as a different vehicle of a same platoon as the ego vehicle 2. For example, if the ego vehicle 2 is better equipped to request assistance compared to the different vehicle, then the ego vehicle 2 may broadcast or transmit a request message to request assistance for the occupant belonging to the different vehicle.

The occupant impairment detecting and addressing system 200, the impairment detecting component 203, and/or the impairment addressing component 210 can be implemented as an ECU or as part of an ECU such as, for example electronic control unit 50. In other embodiments, the occupant impairment detecting and addressing system 200, the impairment detecting component 203, and/or the impairment addressing component 210 can be implemented independently of the ECU. The impairment addressing component 210 in this example includes a communication component 201, and the impairment detecting component 203 (including a processor 206 and memory 208 in this example). Components of the impairment addressing component 210 are illustrated as communicating with each other via a data bus, although other communication in interfaces can be included.

The occupant impairment detecting and addressing system 200 may include a plurality of sensors 152, one or more storage systems 250 which may include servers within or associated within the ego vehicle 2, and one or more other devices 290 which may be external to or internally located within the ego vehicle 2. The one or more storage systems 250 may store impairment statuses, either current or historical, of different occupants within the ego vehicle 2, and associated contextual data including relevant raw sensor data and/or analyzed sensor data related to the impairment statuses. In some embodiments, the one or more storage systems 250 may store impairment statuses, either current or historical, of different occupants within different vehicles within a same platoon as the ego vehicle 2.

In some embodiments, the one or more other devices 290 include one or more different computing or mobiles devices 291, 292, and/or 293, and may be configured to receive a subset (e.g., a portion or all of) outputs from the impairment addressing component 210, and/or the impairment detecting component 203, either in real-time or in a delayed manner via V2N communication. In some embodiments, the one or more other devices 290 may be configured to communicate, verify, or deny an impairment status to the impairment detecting component 203. For example, the impairment detecting component 203 may transmit a communication to the one or more other devices 290 of a predicted impairment status. The one or more other devices 290 may transmit a denial of the predicted impairment status. The denial may be supported or confirmed via performance of one or more fitness and/or reaction tests, and/or other sensor data.

Sensors 152, storage systems 250, and one or more other devices 290 can communicate with the impairment addressing component 210 via a wired or wireless communication interface. Although sensors 152, storage systems 250 and one or more other devices 290 are depicted as communicating with impairment addressing component 210, they can also communicate with each other as well as with other vehicle systems.

Returning to the occupant impairment detecting and addressing system 200, the sensors 152 can include, for example, sensors 52 such as those described above with reference to the example of FIG. 1. Sensors 152 can include additional sensors. In the illustrated example, sensors 152 may include impairment detecting sensors and/or obtain impairment statuses and/or other related data of one or more impairment statuses.

The sensors 152 may include vehicle acceleration sensors 212, vehicle speed sensors 214, wheelspin sensors 216 (e.g., one for each road wheel), head motion sensors 220 to detect rotational and/or translational motion of a head of a driver within the ego vehicle 2, eye tracking sensors 222 to detect eye movements of the driver, and environmental sensors 228 (e.g., to detect traffic density, speed of surrounding traffic, weather, air quality, and/or other environmental conditions). In some embodiments, sensor data from the environmental sensors 228 may affect an action to be determined by the impairment addressing component 210.

For example, if traffic density is high and/or the environment has hazy conditions, then more drastic actions may be taken compared to a situation in which traffic density is low and/or the environment has clear conditions. Thus, the action to be determined may be based on the sensor data, such as a degree of traffic density, a traffic pattern, historical traffic data such as historical traffic patterns, and/or weather conditions such as a degree of haze or visibility.

Additional sensors 232 can also be included as may be appropriate for a given implementation of occupant impairment detecting and addressing system 200. The sensors 152 may be configured to detect and/or alert for any indications of anomalous behavior and/or potential interfering obstacles.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store any information used to detect potential interfering obstacles or generate visual representations, for processor 206 as well as any other suitable information. Memory 208 can be made up of one or more modules of one or more different types of memory, and may be configured to store data and other information as well as operational instructions that may be used by the processor 206.

Although the example of FIG. 3 is illustrated using processor and memory components, as described below with reference to components disclosed herein, the occupant impairment detecting and addressing system 200, including the impairment addressing component 210 and/or the impairment detecting component 203, can be implemented utilizing any form of circuitry including, for example, hardware, software, or a combination thereof. By way of further example, one or more processors, controllers, ASICs, PLAS, PALs, CPLDs, FPGAS, logical components, software routines or other mechanisms might be implemented to make up the occupant impairment detecting and addressing system 200, the impairment addressing component 210 and/or the impairment detecting component 203.

Communication component 201 includes either or both a wireless transceiver component 202 with an associated antenna 205 and a wired I/O interface 204 with an associated hardwired data port (not illustrated). As this example illustrates, communications with the impairment addressing component 210 can include either or both wired and wireless communication components 201. Wireless transceiver component 202 can include a transmitter and a receiver (not shown) to allow wireless communications via any of a number of communication protocols such as, for example, Wifi, Bluetooth, near field communications (NFC), Zigbee, and any of a number of other wireless communication protocols whether standardized, proprietary, open, point-to-point, networked or otherwise. Antenna 214 is coupled to wireless transceiver component 202 and is used by wireless transceiver component 202 to transmit radio signals wirelessly to wireless equipment with which it is connected and to receive radio signals as well. These RF signals can include information of almost any sort that is sent or received by the impairment addressing component 210 to/from other entities such as sensors 152 and storage systems 250.

Wired I/O interface 204 can include a transmitter and a receiver (not shown) for hardwired communications with other devices. For example, wired I/O interface 204 can provide a hardwired interface to other components, including sensors 152 and storage systems 250. Wired I/O interface 204 can communicate with other devices using Ethernet or any of a number of other wired communication protocols whether standardized, proprietary, open, point-to-point, networked or otherwise.

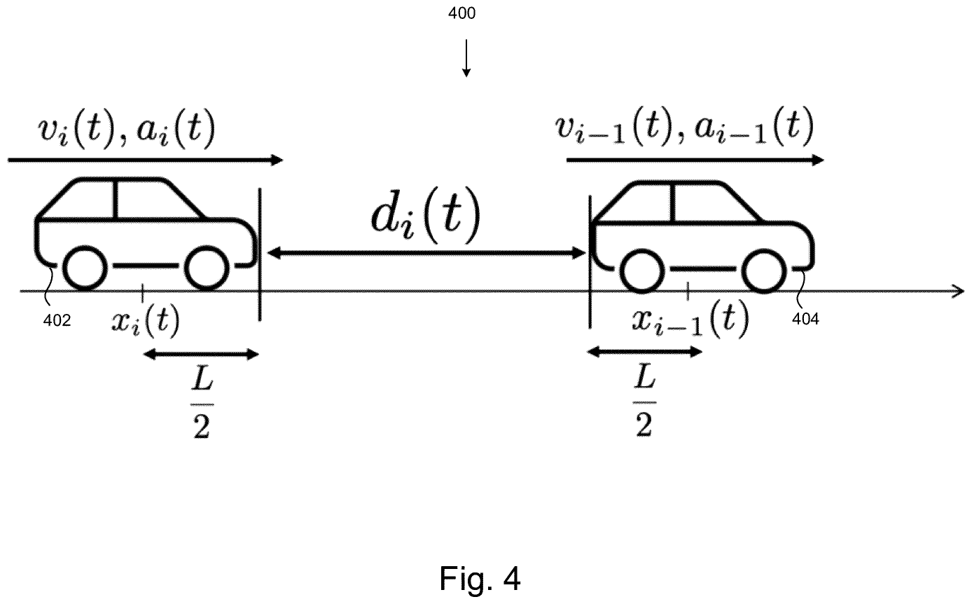

FIG. 4 illustrates a representation 400 of a platoon, which may be implemented in conjunction with previously described figures such as any of FIGS. 1-3. The platoon is intended to be implemented as a string stable vehicle following system. The platoon may include an ego vehicle 402, which may be implemented as the ego vehicle 2, and a different vehicle 404, which may be a lead vehicle. In FIG. 4, two vehicles are illustrated for simplicity. However, a platoon may include any number and/or any configuration of vehicles. In FIG. 4, the ego vehicle 402 is illustrated as a following vehicle, although in other implementations, the ego vehicle 402 may be a lead vehicle rather than a following vehicle. Here, the ego vehicle 402 and the different vehicle 404 may be configured with V2X and/or V2V communication capabilities. In some embodiments, the different vehicle 404 shares, with the ego vehicle 402, its anticipated or predicted future navigation characteristics, such as future trajectory data including anticipated position, anticipated velocity, anticipated acceleration, and/or anticipated heading. In some embodiments, both the different vehicle 404 and the ego vehicle 402 share, with one another, their anticipated future trajectory data.

In FIG. 4, the different vehicle 404 is denoted as i−1, and the ego vehicle 402 is denoted as i. At each time step t, the different vehicle 404 may transmit a message, such as a coded status message, to share N future steps of its anticipated future trajectory, including future positions xᵢ₋₁(t), future velocities vᵢ₋₁(t), and/or future accelerations aᵢ₋₁(t). The ego vehicle 402 and the different vehicle 404 are assumed to have a size indicated by L, and to maintain a distance of dᵢ(t) between each other according to the platoon. Here, N may be a tuning parameter and may represent the intent horizon. A large value of N may require more communication resources, due to more information about the future trajectory of the different vehicle 404. Then, the ego vehicle 402 may utilize this message to be part of a stable car following system. As previously alluded to, the ego vehicle 402, in other implementations may be a lead vehicle, and the ego vehicle 402 may transmit a message to share N future steps of its anticipated future trajectory.

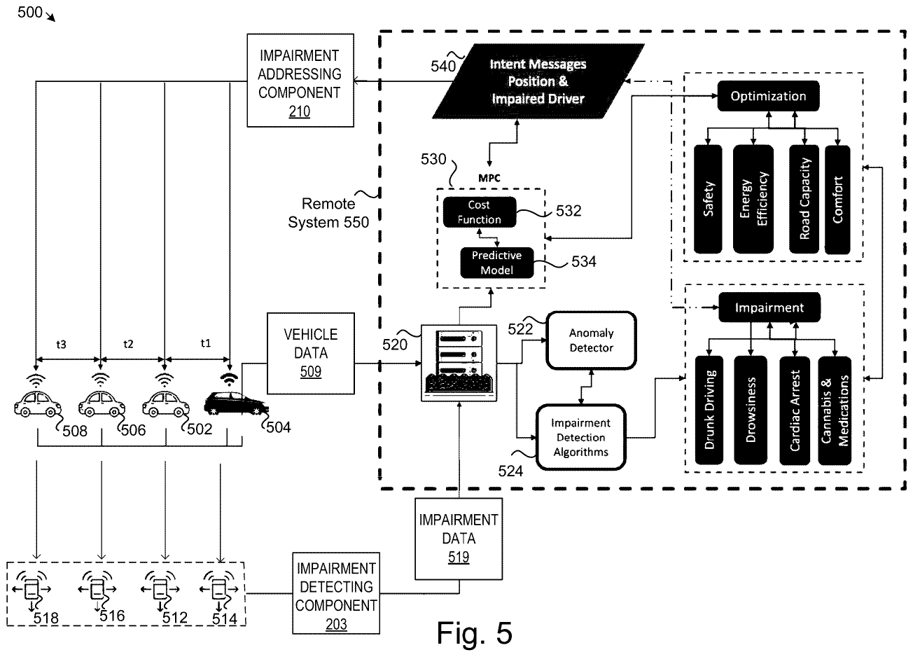

FIG. 5 illustrates a platoon system 500, which may include one or more computer systems or database systems to coordinate operations of a platoon. FIG. 5 may be implemented in conjunction with previously described figures such as any of FIGS. 1-4. The platoon system 500 may include an ego vehicle 502, which may be implemented as the ego vehicle 2, different vehicles 504, 506, and 508, as well as associated sensors 512, 514, 516, and 518 corresponding to the ego vehicle 502 and to the different vehicles 504, 506, and 508, respectively. A separation distance between the different vehicle 504 and the ego vehicle 502 may be equivalent to a time period of t₁. That is, the ego vehicle 502 would take an estimated time period of t₁ to catch up to a current position of the different vehicle 504, based on a current velocity of the ego vehicle 502. A separation distance between the ego vehicle 502 and the different vehicle 506 may be equivalent to a time period of t₂. A separation distance between the ego vehicle 502 and the different vehicle 506 may be equivalent to a time period of t₂. A separation distance between the different vehicle 506 and the different vehicle 508 may be equivalent to a time period of t₂.

The ego vehicle 502 and/or the different vehicles 504, 506, and 508 may belong to a same platoon. In some embodiments, the sensors 512 may be implemented as any of the previously described sensors 152. The sensors 514, 516, and 518 may function in a same or analogous manner as the sensors 512. Here, the ego vehicle 502 is a following vehicle, and the different vehicle 504 is a lead vehicle. In other embodiments, the ego vehicle 502 may be a lead vehicle.

Raw or processed sensor data from the sensors 512, 514, 516, and/or 518 may be captured by the ego vehicle 502, and the different vehicles 504, 506, and/or 508, respectively. The raw or processed sensor data may be fed into the impairment detecting component 203. The raw or processed sensor data may be associated with one or more fitness tests and/or reaction tests, which measure performance characteristics of an occupant in response to certain stimuli and/or certain commands, as previously described. The impairment detecting component 203 may analyze the raw or processed sensor data to generate impairment data 519 which may include an indication of an existence of an impairment, and/or a probability of an impairment. In some embodiments, the impairment detecting component 203 may be implemented as part of the ego vehicle 502, but may also analyze raw or processed sensor data from other vehicles within the same platoon (e.g., the different vehicles 504, 506, and/or 508). In some embodiments, the impairment detecting component 203 may include or be part of a database system. In some embodiments, same or similar database systems may be implemented for the other vehicles within the same platoon (e.g., the different vehicles 504, 506, and/or 508).

The impairment data 519, the raw or processed sensor data 512, 514, 516, and/or 518, and/or vehicle data 509 may be fed into a remote system 550 which performs further characterization, classification, and/or analysis. In some embodiments, the remote system 550 may also include one or more database systems. In some embodiments, the vehicle data 509 may include any data captured by the sensors 152 related to the ego vehicle 502, and/or the different vehicles 504, 506, and/or 508, respectively. In some embodiments, the vehicle data 509 may include navigation characteristics, wheelspin characteristics, and/or any other operational characteristics (e.g., operational statuses indicating whether sensors and other components are functioning and/or an extent of functionality) of any of the ego vehicle 502, and/or the different vehicles 504, 506, and/or 508.

In some embodiments, the remote system 550 may be located within or part of a cloud, edge, or cellular system external to the ego vehicle 502. In some embodiments, any or all of the features described within the remote system 550 may be implemented, or located within, the ego vehicle 502, instead of remote from the ego vehicle 502. Thus, any or all of the features described within the remote system 550 may be implemented as part of the impairment detecting component 203 and/or the impairment addressing component 210.

The remote system 550 may include a repository 520 which may store any of the impairment data 519, the raw or processed sensor data 512, 514, 516, and/or 518, and/or vehicle data 509, and/or historical impairment data, historical raw or processed sensor data, and/or historical vehicle data from any of the ego vehicle 502, and/or the different vehicles 504, 506, and/or 508, and/or from other vehicles within or outside of the platoon. The remote system 550 may include any or all of an anomaly detector 522, one or more impairment detection algorithms 524, and/or a Model Predictive Control (MPC) component 530.

The anomaly detector 522 and/or the one or more impairment detection algorithms 524 may include classical or machine learning models that infer, determine, or predict an impairment status of any occupants within any of the ego vehicle 502, and/or the different vehicles 504, 506, and/or 508. In some embodiments, the anomaly detector 522 may analyze one or more navigation characteristics, such as navigation (e.g., driving) patterns and/or navigation behaviors to detect anomalous navigation patterns and/or navigation behaviors. Examples of anomalous navigation patterns and/or navigation behaviors may include a high degree of instability or erraticism of navigation patterns, or navigation behaviors, and/or deviating from a planned trajectory by at least a threshold amount. In some embodiments, the anomaly detector 522 and/or the one or more impairment detection algorithms 524 may verify, refine, revise, or reject an impairment and/or impairment status that was detected by the impairment detecting component 203. In some embodiments, the anomaly detector 522 and/or the one or more impairment detection algorithms 524 may detect any additional impairments that were undetected by the impairment detecting component 203. In some embodiments, the one or more impairment detection algorithms 524 may determine impairment statuses, including a probability, a type, and/or a level of severity of an impairment. For example, the one or more impairment detection algorithms 524 may include a classification system that classifies the type of impairment, such as a most likely type of an impairment.

The MPC component 530 may include a cost function 532 and one or more predictive models 534. In some embodiments, the MPC component 530 may determine an action to be undertaken in response to determining the impairment statuses. The action may be based on factors such as safety, energy efficiency, road capacity, and/or comfort. In some embodiments, the action may be determined based on historical impairment data of one or more occupants, and/or the vehicle data 509. In some embodiments, the action may include generating one or more messages such as coded status messages, request messages, platooning control messages, and/or safety messages. The coded status messages and/or request messages may be transmitted to other vehicles of a platoon and/or external entities. For example, the coded status messages may indicate the impairment status, and/or a determined action such as a navigation action of a vehicle having an occupant affected by the impairment status, and/or a platoon status of that vehicle. The platoon status may indicate whether or not the vehicle is still part of the platoon and/or a specific role of the vehicle, such as a lead vehicle or a following vehicle. For example, if an occupant within the ego vehicle 502 is determined to be impaired, then the impairment addressing component 210 may transmit one or more coded status messages to the different vehicles 504, 506, and/or 508. In some embodiments, the impairment addressing component 210 may be implemented as part of the ego vehicle 502, but may also address any impairments or potential impairments from other vehicles within the same platoon (e.g., the different vehicles 504, 506, and/or 508). In some embodiments, the impairment addressing component 210 may include or be part of a database system. In some embodiments, same or similar database systems may be implemented for the other vehicles within the same platoon (e.g., the different vehicles 504, 506, and/or 508).

In some embodiments, any of the repository 520, the anomaly detector 522, and/or the impairment detection algorithms 524 may be part of the impairment detecting component 203. In some embodiments, the MPC 530 may be implemented as part of the impairment addressing component 210. Other configurations are also contemplated, such as all or a portion of the MPC 530 being implemented as part of the impairment detecting component 203.

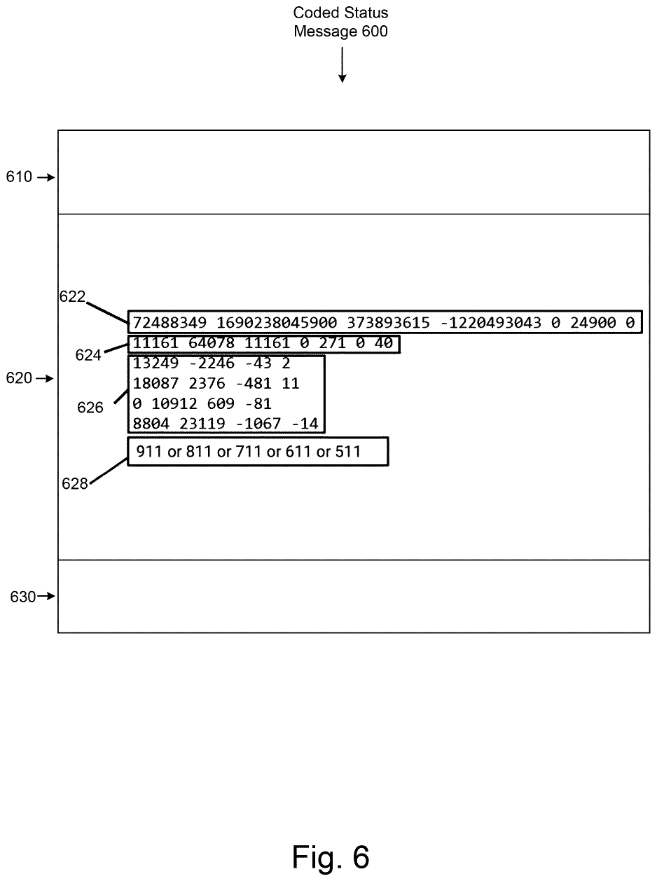

FIG. 6 illustrates an example implementation of a coded status message 600 which may be transmitted by the impairment addressing component 210 as an event-driven message. In some embodiments, the impairment addressing component 210 may transmit the coded status message 600 using short to medium range inter-vehicle communication standards such as Institute of Electrical and Electronics Engineers (IEEE) 802.11p. In some embodiments, the impairment addressing component 210 may transmit the coded status message 600 using protocols such as carrier sense multiple access (CSMA) or time division multiple access (TDMA). In some embodiments, the transmission of the coded status message 600 may occur in vehicular ad hoc networks.

In some embodiments, the coded status message 600 may be in a format of a packet with a header 610, a payload 620, and a footer 630. In some embodiments, the coded status message 600 includes, within the payload 620, one or more codes or representations (hereinafter “representations”) which indicate vehicle and/or occupant data, organized according to distinct sections or rows. The coded status message 600 may merge and/or normalize data from different sources and/or sensors into a standardized format, to be easily decipherable by other vehicle computing systems. This obviates the need for other vehicle computing systems to consume time and computing resources in order to interpret data from different sources, which provides an improvement in computing technology. Not only are resources conserved, but also, vehicle computing systems react immediately to any changing conditions as indicated by the vehicle and/or occupant data represented within the payload 620. The one or more representations may include a location representation 622, a planned trajectory representation 624, a dynamic range representation 626, and/or an impairment status representation 628. The one or more representations may be scaled to be integers. In some embodiments, the location representation 622 may include a system time, a Global Positioning System (GPS) representation of coordinates, and/or position and speed. In some embodiments, the planned trajectory representation 624 may include curvature values and path points or path lengths. For example, the planned trajectory representation 624 may indicate a turn. In some embodiments, the dynamic range representation 626 may indicate speed and/or acceleration limitations, which may be manifested as scaled coefficients of a polynomial representation.

In some embodiments, the impairment status representation 628 may be augmented or overlaid onto the location representation 622, the planned trajectory representation 624, and the dynamic range representation 626. In some embodiments, the impairment status representation 628 includes a selection of different codes. At least some of the codes may indicate a different level of severity of the impairment, a level of volatility or variability of the impairment, and/or a level of control or an amount of loss of control (e.g., of mental and/or physical faculties) due to the impairment. Additionally or alternatively, at least some of the codes may indicate a presence or absence of another vehicle of the platoon at least a threshold distance within the ego vehicle, which may indicate whether or not nearby assistance is available and/or a level of assistance available. For example, a first code may, if selected, may indicate that an impaired driver is in a serious condition (e.g., heart attack), and that other vehicles of the platoon are within a threshold distance of the impaired driver. A second code may, if selected, indicate that an impaired driver is erratic but in control, such as being drowsy and/or exhausted. A third code may, if selected, indicate that an impaired driver is erratic and has at least a threshold probability of losing control, and that other vehicles of the platoon are within a threshold distance of the impaired driver. For example, the third code may indicate a drugged and/or dozing status. A fourth code may, if selected, indicate that a vehicle with a certain level of autonomy, such as L2, may pull over safely with minimal level of danger, due to an impaired occupant such as an inebriated occupant, and that the vehicle has an in-cabin camera to track the impaired occupant. A fifth code may, if selected, indicate a normal operation of a vehicle, and/or that the platoon is string stable.

In some embodiments, the impairment addressing component 210 may initially transmit the coded status message 600 at a baseline frequency. In some embodiments, upon detecting an impairment status, and/or upon detecting a change in impairment status, the impairment addressing component 210 may change a frequency at which the coded status message 600 is transmitted. For example, upon detecting a presence of an impairment or likely impairment, the impairment addressing component 210 may increase a frequency at which the coded status message 600 is transmitted or broadcasted, compared to a previous situation in which no presence of impairment was detected. As another example, if a severity level of an impairment increases, then the impairment addressing component 210 may increase a frequency at which the coded status message 600 is transmitted or broadcasted. As another example, if a severity level of an impairment decreases, then the impairment addressing component 210 may decrease a frequency at which the coded status message 600 is transmitted or broadcasted.

In some embodiments, no media (e.g., images, video, audio) is transmitted in the coded status message 600 in order to ensure privacy. In some embodiments, a type of coded status message to be sent is based on a classification of type of impairment and/or a severity of the impairment. In some embodiments, the impairment addressing component 210 may transmit a deviation message to one or more other vehicles within the platoon if an actual trajectory deviates from a planned trajectory indicated within the planned trajectory representation 624 by at least a threshold amount of degree.

In some embodiments, the coded status message 600 may be translated, for example, using a large language model (LLM) into a status message that is comprehensible by an occupant. The status message may be displayed on a console, dashboard, or other interface within the ego vehicle 2.

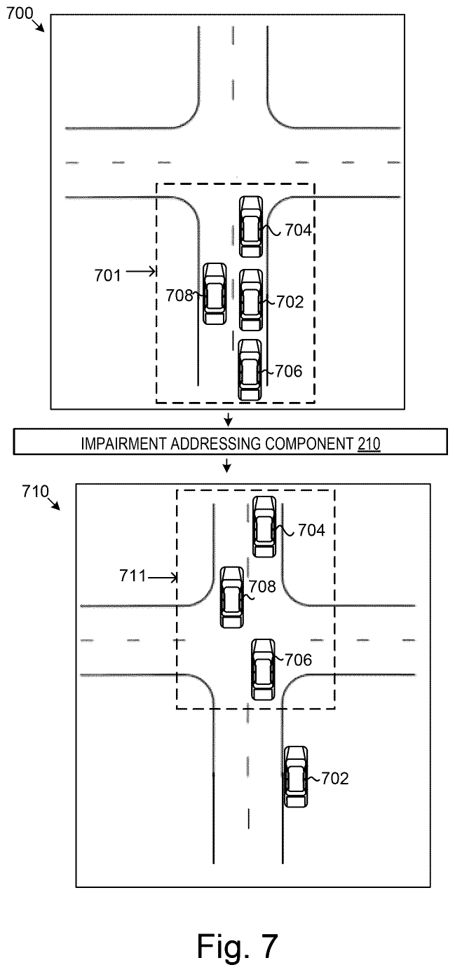

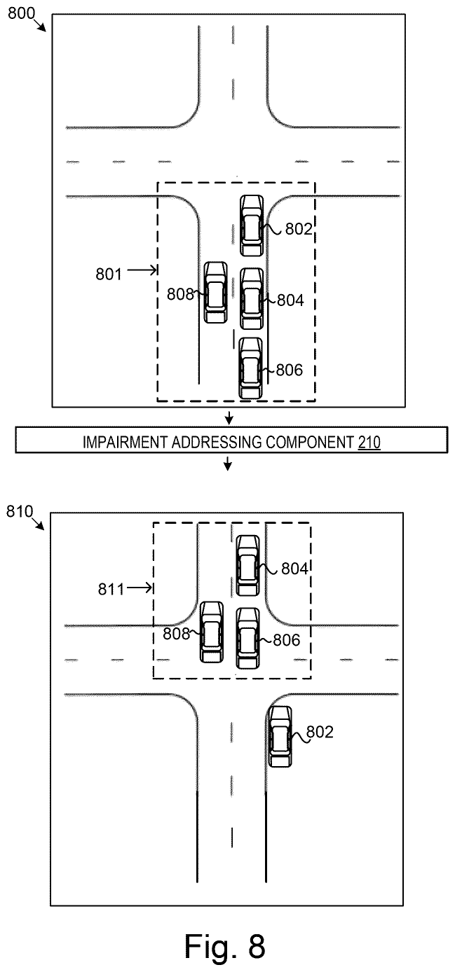

FIGS. 7-8 illustrate scenarios of a platoon in which an impairment causes a change in the platoon, such as a change in a configuration of the platoon. In FIG. 7, a scenario 700 includes a platoon 701 that includes an ego vehicle 702, and different vehicles 704, 706, and 708. The ego vehicle 702 may be implemented as the ego vehicle 2. Although the platoon 701 illustrates four vehicles, a platoon may include any number and any configuration of vehicles. In FIG. 7, the ego vehicle 702 is illustrated as a following vehicle. The impairment addressing component 210, upon receiving an indication that an occupant of the ego vehicle 702 has an impairment status, may selectively perform, or control or program the performance of, a navigation action such as stopping the ego vehicle 702 or pulling over the ego vehicle 702. The impairment addressing component 210, and/or any components within the remote system 550, may selectively change a platoon status of the ego vehicle 702. For example, the impairment addressing component 210, and/or any components within the remote system 550, may remove the ego vehicle 702 from the platoon 701, so that the platoon 701 is transformed into a modified platoon 711 within a scenario 710. In some embodiments, the impairment addressing component 210, and/or any components within the remote system 550, may recruit an other vehicle to replace the ego vehicle 702 within the modified platoon 711. The other vehicle may be part of a waitlist.

In FIG. 8, a scenario 800 includes a platoon 801 that includes an ego vehicle 802, and different vehicles 804, 806, and 808. The ego vehicle 802 may be implemented as the ego vehicle 2. Although the platoon 801 illustrates four vehicles, a platoon may include any number and any configuration of vehicles. In FIG. 8, the ego vehicle 802 is illustrated as a lead vehicle.

The impairment addressing component 210, upon receiving an indication that an occupant of the ego vehicle 802 has an impairment status, may selectively perform, or control or program the performance of, a navigation action such as stopping the ego vehicle 802 or pulling over the ego vehicle 802. The impairment addressing component 210, and/or any components within the remote system 550, may selectively change a platoon status of the ego vehicle 802. For example, the impairment addressing component 210, and/or any components within the remote system 550, may remove the ego vehicle 802 from the platoon 801, so that the platoon 801 is transformed into a modified platoon 811. In some embodiments, the impairment addressing component 210, and/or any components within the remote system 550, may change a platoon status of one or more of the different vehicles 804, 806, and/or 808, so that one of the different vehicles 804, 806, and/or 808 replaces the ego vehicle 802 as the lead vehicle. In some embodiments, the impairment addressing component 210, and/or any components within the remote system 550, may recruit an other vehicle to either be a lead vehicle or a following vehicle within the modified platoon 811. The other vehicle may be part of a waitlist.

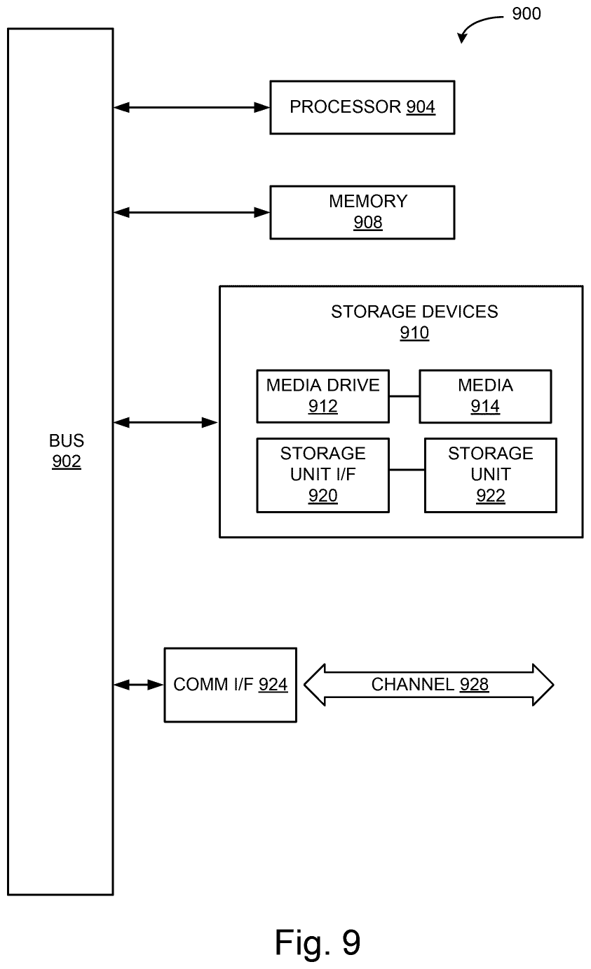

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 9. Various embodiments are described in terms of this example-computing component 900. After reading this description, it will become apparent to a person skilled in the relevant art how to implement the application using other computing components or architectures.

Referring now to FIG. 9, computing component 900 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 900 might also represent computing capabilities embedded within or otherwise available to a given device. For example, a computing component might be found in other electronic devices such as, for example, portable computing devices, and other electronic devices that might include some form of processing capability.

Computing component 900 might include, for example, one or more processors, controllers, control components, or other processing devices. This can include a processor, and/or any one or more of the components. Processor 904 might be implemented using a general-purpose or special-purpose processing engine such as, for example, a microprocessor, controller, or other control logic. Processor 904 may be connected to a bus 902. However, any communication medium can be used to facilitate interaction with other components of computing component 900 or to communicate externally.

Computing component 900 might also include one or more memory components, simply referred to herein as main memory 908. For example, random access memory (RAM) or other dynamic memory, might be used for storing information and instructions to be executed by processor 904. Main memory 908 might also be used for storing temporary variables or other intermediate information during execution of instructions to be executed by processor 904. Computing component 900 might likewise include a read only memory (“ROM”) or other static storage device coupled to bus 902 for storing static information and instructions for processor 904.

The computing component 900 might also include one or more various forms of information storage mechanism 910, which might include, for example, a media drive 912 and a storage unit interface 920. The media drive 912 might include a drive or other mechanism to support fixed or removable storage media 914. For example, a hard disk drive, a solid-state drive, a magnetic tape drive, an optical drive, a compact disc (CD) or digital video disc (DVD) drive (R or RW), or other removable or fixed media drive might be provided. Storage media 914 might include, for example, a hard disk, an integrated circuit assembly, magnetic tape, cartridge, optical disk, a CD or DVD. Storage media 914 may be any other fixed or removable medium that is read by, written to or accessed by media drive 912. As these examples illustrate, the storage media 914 can include a computer usable storage medium having stored therein computer software or data.

In alternative embodiments, information storage mechanism 910 might include other similar instrumentalities for allowing computer programs or other instructions or data to be loaded into computing component 900. Such instrumentalities might include, for example, a fixed or removable storage unit 922 and an interface 920. Examples of such storage units 922 and interfaces 920 can include a program cartridge and cartridge interface, a removable memory (for example, a flash memory or other removable memory component) and memory slot. Other examples may include a PCMCIA slot and card, and other fixed or removable storage units 922 and interfaces 920 that allow software and data to be transferred from storage unit 922 to computing component 900.

Computing component 900 might also include a communications interface 924. Communications interface 924 might be used to allow software and data to be transferred between computing component 900 and external devices. Examples of communications interface 924 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 924 may be carried on signals, which can be electronic, electromagnetic (which includes optical) or other signals capable of being exchanged by a given communications interface 924. These signals might be provided to communications interface 924 via a channel 928. Channel 928 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 908, storage unit 920, media 914, and channel 928. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 900 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Reference to A “and” B may be construed to also encompass the scenario of A “or” B. Reference to A “or” B may be construed to also encompass the scenario of A “and” B. Any reference to a “threshold” or “sufficiency” may be construed to encompass any applicable value or degree, such as any applicable value or degree sufficient to satisfy a given outcome. In some examples, a threshold level, similarity or degree thereof may be construed to include any values such as 99 percent, 98 percent, 95 percent, 90 percent, 80 percent, 75 percent, or any other value therebetween, or any ranges therebetween. Additionally or alternatively, a threshold similarity or degree may be construed as qualitatively satisfying some condition, such as presence of one or more common features. Any reference to sufficiently similar may also be construed to encompass same or similar meanings as satisfying a threshold. Reference to “likely,” “a likelihood,” or “probable” or any variation thereof may be construed as satisfying some threshold likelihood or probability.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system associated with an ego vehicle, the system comprising:
one or more sensors configured to obtain occupant data of an occupant within the ego vehicle, where the ego vehicle is part of a platoon of vehicles;
one or more processors;
a memory storing instructions that, when executed by the one or more processors, cause the system to perform:
determining, based on the occupant data, an impairment status of the occupant; and
in response to determining the impairment status, selectively implementing an action to address the impairment status, wherein the action comprises:
communicating, using one or more coded status messages, at least a portion of the impairment status to one or more other vehicles in the platoon; and
implementing a navigation action of the ego vehicle based on the impairment status.

2. The system of claim 1, wherein the impairment status indicates a type or a severity level of an impairment of the occupant.

3. The system of claim 2, wherein the impairment status indicates the type of the impairment, and the type of the impairment comprises a medical-related impairment excluding inebriation.

4. The system of claim 3, wherein the type of the impairment comprises a cardiovascular impairment.

5. The system of claim 2, wherein the impairment status indicates the severity level of the impairment, and the severity level is based on a degree of control of physical or mental faculties maintained by the occupant following the impairment.

6. The system of claim 1, wherein the one or more coded status messages indicate a presence or absence of another vehicle of the platoon at least a threshold distance within the ego vehicle.

7. The system of claim 1, wherein the system comprises a database system, and the communicating of at least the portion of the impairment status is directed to one or more other database systems associated with one or more respective other vehicles in the platoon.

8. The system of claim 1, wherein the communicating of at least the portion of the impairment status comprises:
broadcasting the one or more coded status messages at a frequency;
obtaining a changed impairment status; and
in response to obtaining the changed impairment status, changing the frequency at which the one or more coded status messages corresponding to the changed impairment status is broadcasted.

9. The system of claim 1, wherein the one or more sensors are further configured to obtain one or more navigation characteristics, the navigation characteristics being indicative of a degree of stability of navigation of the ego vehicle, and the determining of the impairment status is based on the one or more navigation characteristics.

10. The system of claim 1, wherein the navigation action causes an ego vehicle navigation characteristic of the ego vehicle to change with respect to a navigation characteristic of a different vehicle within the platoon or causes the ego vehicle to change a platoon status within the platoon.

11. A vehicle control system for a vehicle, comprising:
a processor; and
a memory coupled to the processor to store instructions, which when executed by the processor, cause the processor to perform operations, the operations comprising:
obtaining occupant data from one or more sensors, the occupant data being associated with an occupant within an ego vehicle, wherein the vehicle is part of a platoon of vehicles;
determining, based on the occupant data, an impairment status of the occupant; and
in response to determining the impairment status, selectively implementing an action to address the impairment status, wherein the action comprises:
communicating, using one or more coded status messages, at least a portion of the impairment status to one or more other vehicles in the platoon; and
implementing a navigation action of the ego vehicle based on the impairment status.

12. The vehicle control system of claim 11, wherein the impairment status indicates a type or a severity level of an impairment of the occupant.

13. The vehicle control system of claim 12, wherein the impairment status indicates the type of the impairment, and the type of the impairment comprises a medical-related impairment excluding inebriation.

14. The vehicle control system of claim 13, wherein the type of the impairment comprises a cardiovascular impairment.

15. The vehicle control system of claim 12, wherein the impairment status indicates the severity level of the impairment, and the severity level is based on a degree of control of physical or mental faculties maintained by the occupant following the impairment.

16. The vehicle control system of claim 11, wherein the one or more coded status messages indicate a presence or absence of another vehicle of the platoon at least a threshold distance within the ego vehicle.

17. The vehicle control system of claim 11, wherein the vehicle control system comprises a plurality of database systems associated with respective other vehicles in the platoon, and the communicating of at least the portion of the impairment status comprises communicating, from a database system associated with the ego vehicle, to at least a portion of the plurality of database systems.

18. The vehicle control system of claim 11, wherein the communicating of at least the portion of the impairment status comprises:
broadcasting the one or more coded status messages at a frequency;
obtaining a changed impairment status; and
in response to obtaining the changed impairment status, changing the frequency at which the one or more coded status messages corresponding to the changed impairment status is broadcasted.

19. The vehicle control system of claim 11, wherein the operations further comprise:
obtaining one or more navigation characteristics, the navigation characteristics being indicative of a degree of stability of navigation of the ego vehicle; and the determining of the impairment status is based on the one or more navigation characteristics.

20. The vehicle control system of claim 11, wherein the navigation action causes an ego vehicle navigation characteristic of the ego vehicle to change with respect to a navigation characteristic of a different vehicle within the platoon or causes the ego vehicle to change a platoon status within the platoon.
